(19) United States
(12) Patent Application Publication
(10) Pub. No.: US 2023/0405802 A1
(43) Pub. Date: Dec. 21, 2023

(54) TEACHING SYSTEM USING WIRELESS TEACHING PENDANT

(71) Applicant: FUJI CORPORATION, Chiryu (JP)

(72) Inventor: Hideru MATSUSHIMA, Owariasahi-shi (JP)

(73) Assignee: FUJI CORPORATION, Chiryu (JP)

(21) Appl. No.: 18/338,007

(22) Filed: Jun. 20, 2023

(30) Foreign Application Priority Data
Jun. 20, 2022 (JP) 2022-098885

(51) Int. Cl. B25J 9/00; B25J 13/00; B25J 9/16

(52) U.S. Cl. CPC B25J 9/0081; B25J 9/0093; B25J 9/1682; B25J 13/006

(57) ABSTRACT

A teaching system using a wireless teaching pendant is provided. Provided is a teaching system using a wireless teaching pendant including a communication device configured to perform a wireless connection between multiple robots, and a display device configured to display, as selection information, an identification mark attached to each robot for identifying the multiple robots on a selection screen for a wireless connection of one robot which is a teaching target among the multiple robots, in which, for example, the wireless teaching pendant displays an identification mark of the robot of which a wireless connection is completed on the display device, and particularly the identification mark displayed on the display device has a different identification color set for each robot.

### TECHNICAL FIELD

The present invention relates to a teaching system using a wireless teaching pendant in which multiple robots are used as teaching targets and teaching is enabled by an appropriate wireless connection with each robot.

### BACKGROUND ART

An automatic workpiece conveyer is provided on a processing machine line on which multiple machine tools are arranged, and a workpiece is delivered by a workpiece conveyance robot moving with respect to each machine tool. Although the series of operations of such a workpiece conveyance robot are stored as a program, a predetermined operation is stored by teaching. In the teaching, a teaching pendant is used, and the operation is stored by an operator actually operating the workpiece conveyance robot. Patent Literature 1 also discloses a technique related to teaching using a teaching pendant for a robot.

In the conventional art, the teaching pendant connected by a cable is used as a portable operation device for creating (teaching) the program for operating the robot. The teaching pendant is provided with an operation section including various switches, buttons, and the like for performing operations, such as the teaching, and a display section that displays teaching data during the teaching, a control state of the robot, and the like. In particular, in the conventional art, a display color is set for each command, and in a case where the teaching data is displayed, the display on the display section is performed by the color thereof.

### PATENT LITERATURE

Patent Literature 1: JP2013-39626A

### SUMMARY OF THE INVENTION

### Technical Problem

Incidentally, in a case where multiple automatic workpiece conveyers are used on a processing machine line on which multiple machine tools are arranged and the wireless connection teaching pendant is used, since the movement is free, all operations can be performed even in a case of one wireless connection teaching pendant, so that the work efficiency can be improved. However, in a case where one of multiple workpiece conveyance robots is selected and wirelessly connected, a case where the recognition of an operator and an actual connection state are different from each other may occur. Although the case may occur due to a mistake of the operator, in a case where the teaching is performed without being aware of the mistake, the workpiece conveyance robot that is not viewed by the operator is operated, a collision is caused, and a damage is caused. Therefore, in the work in which the multiple robots are used as the teaching targets and the wireless teaching pendant is used, it is important to avoid such carelessness of the operator.

Accordingly, an object of the present invention is to provide a teaching system using a wireless teaching pendant in order to solve such problems.

### Solution to Problem

A teaching system using a wireless teaching pendant of the present invention includes a communication device configured to perform a wireless connection between multiple robots, and a display device configured to display, as selection information, an identification mark attached to each robot for identifying the multiple robots on a selection screen for a wireless connection of one robot which is a teaching target among the multiple robots.

### Advantageous Effect of the Invention

With the above configuration, in a case where the wireless teaching pendant that can perform the wireless connection between the multiple robots is wirelessly connected to the corresponding robot, the identification mark attached to the robot side in order to identify each robot and the identification mark displayed on the selection screen of the wireless teaching pendant, so that a mistake in the connection by the operator can be avoided.

### BRIEF DESCRIPTION OF DRAWINGS

FIG. 1 is a front view showing a processing machine line on which a wireless teaching system of the present embodiment is mounted.

FIG. 2 is a side view showing a workpiece conveyance robot.

FIG. 3 is an image diagram showing a wireless connection by one wireless teaching pendant in which five automatic workpiece conveyers are used as targets.

FIG. 4 is a diagram showing a selection screen displayed on a liquid crystal display panel of the wireless teaching pendant.

FIG. 5 is a diagram showing an operation screen displayed on the liquid crystal display panel of the wireless teaching pendant.

### DESCRIPTION OF EMBODIMENTS

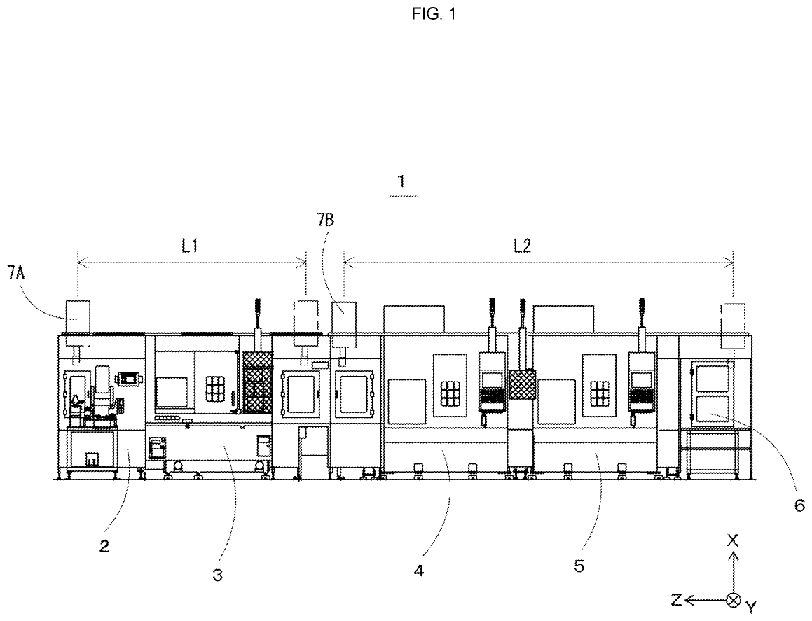

One embodiment of a teaching system using a wireless teaching pendant of the present invention will be described below with reference to the accompanying drawings. FIG. 1 is a front view showing a processing machine line on which a teaching system of the present embodiment is mounted. In machine processing line 1, three machine tools 3, 4, and 5 are disposed side by side in close to each other, and predetermined processing is performed at each location by workpiece conveyance to a right side in the drawing. Further, in processing machine line 1, measurement device 2 is disposed at a left end in the drawing, which is a workpiece input side, and workpiece stocker 6 is disposed at a right end of a workpiece output side.

Since processing machine line 1 has a lateral width of about 10 m and a conveying distance of a workpiece is long, multiple conveyers are provided. Specifically, the workpiece is automatically conveyed from measurement device 2 to machine tools 3, 4, and 5 and workpiece stocker 6 by first and second automatic workpiece conveyers 7A and 7B. First automatic workpiece conveyer 7A is in charge of conveying the workpiece between measurement device 2 and machine tool 3, and movement distance L1 for conveying the workpiece is about 3.4 m. In addition, second automatic workpiece conveyer 7B is in charge of conveying the workpiece between machine tools 4 and 5, and workpiece stocker 6, and movement distance L2 for conveying the workpiece is about 5.8 m.

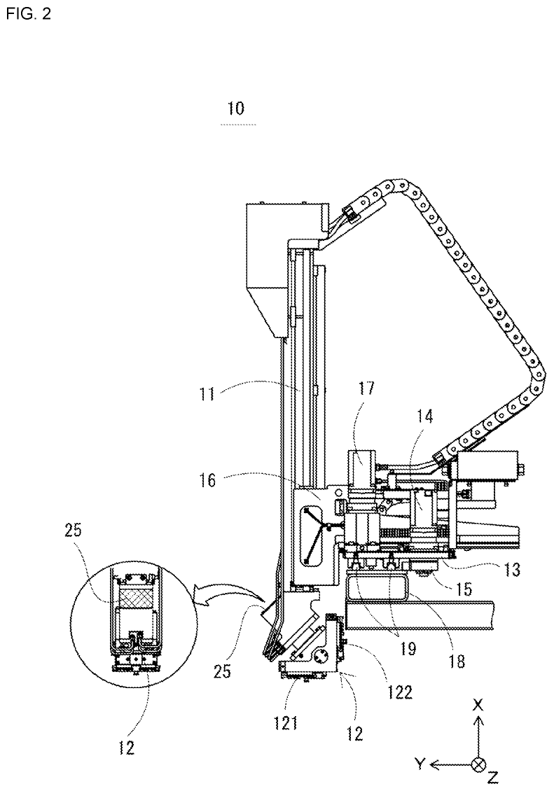

First and second automatic workpiece conveyers 7A and 7B of the present embodiment are both gantry-type autoloaders having the same structure, and the workpiece is conveyed by the operation of the workpiece conveyance robot. FIG. 2 is a side view showing the workpiece conveyance robot. Workpiece conveyance robot 10 has robot hand 12 assembled to a lower end portion of vertical lifting and lowering arm 11, and is configured to move along Z-axis steel pipe 18 built in a ceiling portion of each of measurement device 2, machine tools 3, 4, 5, and workpiece stocker 6. Two guide rails 19 parallel to each other in the same direction are provided on Z-axis steel pipe 18 built in a longitudinal direction of processing machine line 1.

Workpiece conveyance robot 10 is assembled on traveling table 13 that is slidable on guide rail 19 thereof, and can move in the longitudinal direction in processing machine line 1. Z-axis servo motor 14 is fixed to traveling table 13, and pinion 15 fixed to a rotary shaft thereof meshes with a rack fixed to Z-axis steel pipe 18 side. Therefore, pinion 15 meshed with the rack rolls by a rotational control of Z-axis servo motor 14, so that workpiece conveyance robot 10 can move in a Z-axis direction. In the present embodiment, the description will be made by defining the longitudinal direction of processing machine line 1 on which machine tools 3, 4, and 5 are arranged as the Z-axis direction, defining an up-down direction as an X-axis direction, and defining a front-rear direction as a Y-axis direction.

Workpiece conveyance robot 10 has a configuration for moving robot hand 12 in the front-rear direction and the up-down direction of a body on traveling table 13. Slide base 16 that is slidable in the front-rear direction of the body is assembled on an upper surface of traveling table 13, and Y-axis servo motor 17 including a pinion on a rotary shaft is fixed to traveling table 34. Further, a rack is fixed to a side surface of slide base 16, so that the pinion of the Y-axis servo motor 17 meshes with the rack.

In addition, lifting and lowering arm 11 is slidably supported in a vertical posture on a front portion of slide base 16, and an X-axis servo motor (not shown) is provided on traveling table 13 side. A pinion is fixed to a rotary shaft of such an X-axis servo motor, and meshes with a rack fixed to lifting and lowering arm 11. Robot hand 12 for holding the workpiece is assembled to the lower end portion of lifting and lowering arm 11. Robot hand 12 is provided with chuck mechanisms 121 and 122 at an angle of 90°, and the positions thereof in a lower direction and a lateral direction can be exchanged by a pivoting mechanism.

First and second automatic workpiece conveyers 7A and 7B are driven and controlled by workpiece conveyance robot 10 in accordance with a workpiece conveyance program. That is, robot hand 12 moves to a set position in accordance with the processing of the workpiece, and the workpiece is delivered by chuck mechanisms 121 and 122. In order to create such a workpiece conveyance program, a teaching operation using the teaching pendant is performed by an operator. In this case, in a case where the movement distance is long as in a case of workpiece conveyance robot 10, a wired teaching pendant is provided for each automatic workpiece conveyer in consideration of a length of a cable.

Meanwhile, the wireless teaching pendant includes a wireless communication device that can perform an information communication with each of multiple automatic workpiece conveyers, and can perform the teaching with respect to multiple automatic workpiece conveyers by one wireless teaching pendant through switching of connections. Therefore, the wireless teaching pendant can freely move without wiring the cable, and is effective for workpiece conveyance robot 10 having a long movement distance, such as processing machine line 1. In addition, in some cases, multiple processing machine lines including automatic workpiece conveyers are installed in a processing factory, and in a case where the wireless teaching pendant is used, it is also possible to perform the teaching with respect to more automatic workpiece conveyers.

However, in a case where the teaching is performed with respect to multiple workpiece conveyance robots 10 by one wireless teaching pendant, a possibility of causing an erroneous operation is increased correspondingly. In a case of the wireless connection with the teaching target, for example, although workpiece conveyance robot 10A should be selected for the teaching with respect to first automatic workpiece conveyer 7A, a case where workpiece conveyance robot 10B of second automatic workpiece conveyer 8 is actually wirelessly connected due to the carelessness of the operator may occur. Such a case is more likely to occur in a factory or the like in which many automatic workpiece conveyers are used as the teaching targets. In a case where the operator performs the operation without being aware of the mistake, second automatic workpiece conveyer 8 that is not in front of the operator's eyes is moved, so that workpiece conveyance robot 10B collides and is damaged in the machine.

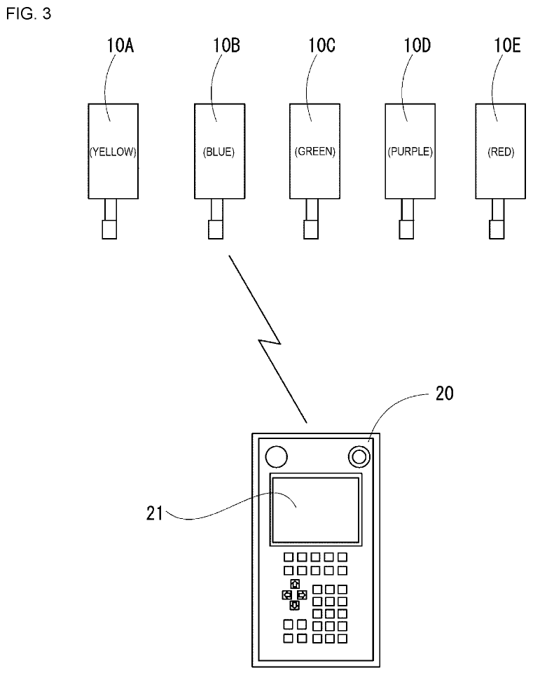

In the present embodiment, the teaching system for avoiding the mistake by the operator in a case where the wireless teaching pendant is used is constructed. For example, FIG. 3 is an image diagram showing a wireless connection by one wireless teaching pendant in which five automatic workpiece conveyers are used as the teaching targets. In the teaching work, the wireless connection with automatic workpiece conveyer selected from among five automatic workpiece conveyers 7A, 7B, 7C, 7D, and 7E (collectively, referred to as automatic workpiece conveyer 7) is performed by one wireless teaching pendant 20, and any of workpiece conveyance robots 10A, 10B, 10C, 10D, and 10E (collectively, referred to as workpiece conveyance robot 10) is actually operated as shown in FIG. 3.

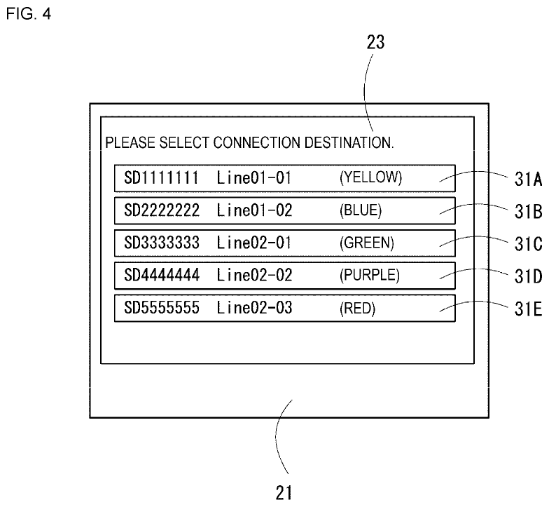

FIG. 4 shows selection screen 23 displayed on liquid crystal display panel 21 of wireless teaching pendant 20. On liquid crystal display panel 21 of wireless teaching pendant 20, selection screen 23 as shown in FIG. 4 is displayed by a display switching button. On selection screen 23, selection buttons 31A, 31B, 31C, 31D, and 31E (collectively, referred to as selection button 31) of workpiece conveyance robots 10A, 10B, 10C, 10D, and 10E that can be wirelessly connected to wireless teaching pendant 20 are displayed. Selection button 31 displays the line number of the processing machine line and the disposition number of automatic workpiece conveyer 7 on the line, in addition to the identification number of workpiece conveyance robot 10 as selection information.

Further, in the selection information of selection button 31, the button itself is displayed by an identification color that is set in advance. That is, unique identification colors are set for workpiece conveyance robots 10A, 10B, 10C, 10D, and which are the teaching targets, respectively, and selection button 31 is also color-coded to correspond to the identification color. Therefore, to selection buttons 31A, 31B, 31C, 31D, and 31E of selection screen 23, identification colors are added as the selection information, and thus the display is performed in yellow, blue, green, purple, and red.

Such an identification color is also displayed on automatic workpiece conveyer 7, and chuck cover 25 (see FIG. 2) of workpiece conveyance robot 10 is coated in the corresponding color, or a label of the identification color is affixed to serve as an identification mark. For example, the colors of chuck covers 25 as the identification color are yellow in first automatic workpiece conveyer 7A indicated by selection button 31A and blue in second automatic workpiece conveyer 7B indicated by selection button 31B, respectively. In addition, in the first, second, and third automatic workpiece conveyers on the second processing machine line (not shown), the colors of chuck covers 25 are green, purple, and red, respectively.

As in the front view shown in a round frame in FIG. 2, chuck cover 25 is positioned on a front surface side of workpiece conveyance robot 10, and is positioned on a front surface as viewed from the operator who stands in front of processing machine line 1 in order to perform the teaching work. In particular, since chuck cover 25 is disposed in the vicinity of robot hand 12, in a case where the teaching with respect to workpiece conveyance robot 10 is performed, chuck cover 25 always comes into a view of the operator. Although the colors are used as the identification marks in the present embodiment, symbols, characters, icons, or the like may be used as the identification marks in addition to the colors.

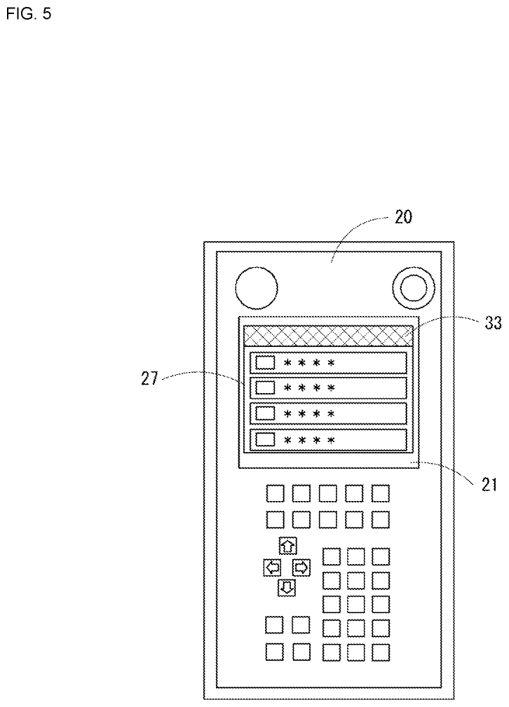

Next, FIG. 5 shows an operation screen displayed on liquid crystal display panel 21 of wireless teaching pendant 20. In wireless teaching pendant 20, liquid crystal display panel 21 is switched to the operation screen shown in FIG. 5 by the operation of selection button 31. Then, the same identification color as operated selection button 31 is displayed on operation screen 27. In operation screen 27, band-shaped color display portion 33 is provided on an upper portion of the screen, and an identification color corresponding to the portion, that is, the identification mark is displayed. A peripheral portion may be displayed by the identification color in addition to a part of operation screen 27, or the entire background of operation screen 27 may be displayed by the corresponding identification color.

In wireless teaching pendant 20, the color corresponding to automatic workpiece conveyer 7 to be wirelessly connected in this manner, that is, the same identification color as chuck cover 25 is set in advance and stored. Then, in response to the operation, a predetermined identification color is displayed on selection screen 23 or operation screen 27 of liquid crystal display panel 21. In addition, such an identification mark, that is, the information of the identification color may be stored in a storage section of automatic workpiece conveyer 7. In such a case, in the display of the identification color on operation screen 27, the information on the identification color is acquired from automatic workpiece conveyer 7 to which wireless teaching pendant 20 is wirelessly connected, and correspondingly, a predetermined color is displayed on the screen of liquid crystal display panel 21 in the same manner.

Subsequently, in a case where the operator performs the teaching work, the operator holds wireless teaching pendant 20 and stands in front of the automatic workpiece conveyer (for example, the second automatic workpiece conveyer 7B) that is the teaching target. Then, by the operator selecting selection button 31B from selection screen 23 of liquid crystal display panel 21 shown in FIG. 4, liquid crystal display panel 21 is switched to operation screen 27. In this case, in a case where the operator views chuck cover 25 of workpiece conveyance robot 10B, an operation for confirming blue in selection button 31B is performed, so that the blue matching chuck cover 25 can be confirmed also in color display portion 33 of operation screen 27.

Therefore, it is possible to avoid the carelessness that mistakes the teaching target at the stage of connecting wireless teaching pendant 20. However, there is also a case where the operator wirelessly connects wireless teaching pendant 20 without viewing chuck cover 25. Then, it is conceivable that a mistaken wireless connection is performed with automatic workpiece conveyer 7, so that the operator proceeds to the teaching work as it is. In the conventional art, the operator is aware of the mistake first time only after operating the workpiece conveyance robot, but in the present embodiment, the operator can be aware of the mistake by a difference in color between operation screen 27 of wireless teaching pendant 20 viewed by the operator and workpiece conveyance robot 10B (chuck cover 25) that is the teaching target.

In particular, since, in a case where the teaching is performed, the operator stands in front of workpiece conveyance robot 10B and operates wireless teaching pendant 20 in front of the chest, operation screen 27 and chuck cover 25 of workpiece conveyance robot 10 has a positional relationship in which operation screen 27 and chuck cover 25 of workpiece conveyance robot 10 easily comes into the view simultaneously. That is, it is easy for the operator to be aware of the difference in color. Therefore, the operator who is aware of the difference in color can recognize that the target of the wireless connection is mistaken, before performing the operation, and can perform the correct teaching work by switching to the wireless connection with the original automatic workpiece conveyer.

Heretofore, one embodiment of the present invention has been described, but the present invention is not limited to this, and various modifications can be made without departing from the gist thereof.

For example, in the embodiment, the configuration of the identification mark is set to a color and the identification color is attached to chuck cover 25, but entire workpiece conveyance robot 10A, 10B, 10C, 10D, 10E or conspicuous components, such as lifting and lowering arm 11, may be coated with a corresponding identification color. Further, the identification mark may be attached to a predetermined position on the surface of the body of machine tool 3 or the like on which workpiece conveyance robot 10 moves.

### REFERENCE SIGNS LIST

1: machine processing line, 3, 4, 5: machine tool, 7A, 7B: automatic workpiece conveyer, 10: workpiece conveyance robot, 12: robot hand, 20: wireless teaching pendant, 21: liquid crystal display panel, 23: selection screen, 25: chuck cover, 27: operation screen, 31: selection button, 33: color display portion

1. A teaching system using a wireless teaching pendant comprising:
a communication device configured to perform a wireless connection between multiple robots; and
a display device configured to display, as selection information, an identification mark attached to each robot for identifying the multiple robots on a selection screen for a wireless connection of one robot that is a teaching target among the multiple robots.

2. The teaching system using a wireless teaching pendant according to claim 1,
wherein the wireless teaching pendant is configured to display an identification mark of the robot of which a wireless connection is completed on the display device.

3. The teaching system using a wireless teaching pendant according to claim 2,
wherein the identification mark displayed on the display device of the wireless teaching pendant has a different identification color set for each robot.

4. The teaching system using a wireless teaching pendant according to claim 1,
wherein the robots are workpiece conveyance robots of multiple automatic workpiece conveyers provided on a processing machine line, and the identification mark is attached to a front side of a body of a robot hand including a chuck mechanism configured to hold a workpiece.
